(19) United States
(12) Patent Application Publication
(10) Pub. No.: US 2018/0068344 A1
(43) Pub. Date: Mar. 8, 2018

(54) SYSTEMS AND METHODS FOR MANAGEMENT OF MEDIA CAMPAIGNS

(71) Applicant: Jennifer L. Sultzaberger, Maricopa, AZ (US)

(72) Inventor: Jennifer L. Sultzaberger, Maricopa, AZ (US)

(21) Appl. No.: 15/705,249

(22) Filed: Sep. 14, 2017

Related U.S. Application Data
(63) Continuation-in-part of application No. 14/484,244, filed on Sep. 11, 2014, now Pat. No. 9,799,051.
(60) Provisional application No. 61/891,391, filed on Oct. 15, 2013.

(51) Int. Cl. G06Q 30/02; G06F 17/30; G06Q 10/06

(52) U.S. Cl. CPC G06Q 30/0246; G06F 17/30876; G06F 17/3082; G06Q 30/0244; G06Q 10/06393

(57) ABSTRACT

The present invention relates to systems and methods for campaign management. Such systems and methods include receiving a keyword, and validating the keyword against an internal database of active campaign keywords. The keyword is also assessed for quality using one or more third party valuation algorithms. If needed, alternative keywords may be recommended if the original keyword's quality is below a threshold. Content associated with the keyword is then received. The content and keywords are rolled out to various platforms. Analytics from these platforms are collected and displayed on an analytics interface, along with the content and a landing page associated with the campaign.

### CROSS REFERENCE TO RELATED APPLICATIONS

This application is a continuation-in-part and claims of the benefit of U.S. application Ser. No. 14/484,244 filed Sep. 11, 2014, which application claims the benefit of and is a non-provisional application of U.S. provisional application No. 61/891,391 filed on Oct. 15, 2013, which applications are hereby fully incorporated in their entirety by this reference.

### BACKGROUND

The present invention relates to systems and methods for management of media campaigns to enhance advertising, brand recognition, and customer outreach. Such systems and methods are particularly useful in the context of online activities, and may be especially useful in social media and advertising. Such systems and methods enable users to make their media more searchable, consolidates campaign information across multiple platforms in a user friendly interface, and enables ready access to campaign analytics. Such systems and methods enhancing page-hits and ultimately marketing efficacy and/or ad revenue that may be collected.

Currently, a number of social media sites allow users to upload their media. Some media sites also enable the uploader to collect advertisement revenue based upon the number of “hits” the user's site gets. Popular sites can elicit huge numbers of page-hits through word of mouth and sharing of the media. These large numbers of page hits can generate substantial quantities of money for a select few users. However, for the vast majority of users, their content is often lost in the heard, and relatively few page hits are actually realized. The same is true for marketers who are not particularly concerned with the direct advertisement revenue. If the content is not widely viewed, then it is ineffective as a marketing or informational tool.

One way to increase page hits is to develop a dedicated fan base which views the user's content of a reoccurring basis. However, developing this sort of fan base is difficult, especially prior to the user gaining much traction.

In order for users to generate that initial traction, the prevailing wisdom is to make the content readily searchable for the consuming audience. This has traditionally involved tagging the content extensively, and providing media descriptions that will match what a typical user types in as a search. However, despite these measures to make the media more searchable, it still tends to get lost in the vast quantity of media in existence.

Further, even when content is successfully deployed on a social media site, the prevailing wisdom is that advertising campaigns are best performed across multiple platforms. Ensuring continuity of the campaign across the various platforms is difficult and time consuming. Further, due to the disconnected nature of the various platforms, properly ascertaining the effectiveness of a campaign, in its entirety, can be a challenge.

It is therefore apparent that an urgent need exists for systems and methods for management of media campaigns across platforms. Such systems and methods would be able to provide increased ability to use media platforms for marketing, information sharing, or for direct advertisement revenue generation (monetization).

### SUMMARY

To achieve the foregoing and in accordance with the present invention, systems and methods for management of media campaigns are provided. Such systems and methods enable users to have their uploaded media be more searchable in an organic manner, and enables better management of their media campaigns across multiple platforms by providing a consolidated interface for reviewing the media, platform outlets, landing pages, and analytics. The system may also enable improved selection of keywords to maximize campaign effectiveness. This enhanced search-ability of keywords, and management of the media campaigns, enables more frequent population of the media in search engines, and therefore enables enhanced monetization through advertisements, increases marketing efficacy, and enables greater dissemination of information.

In some embodiments, the systems and methods include receiving a keyword, and validating the keyword against an internal database of active campaign keywords. This validation may also include comparing the keyword against other external databases, such as trademark records. The keyword is also assessed for quality using one or more third party valuation algorithms. These valuations may be weighted and averaged, and can be further modified by keyword length and/or semantic analysis. If needed, alternative keywords may be recommended if the original keyword's quality is below a threshold. This recommendation may involve using marketer suggestions and/or synonym replacement methodologies.

Content associated with the keyword is then received. The content and keywords are rolled out to various platforms. Analytics from these platforms are collected and displayed on an analytics interface, along with the content and a landing page associated with the campaign.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example functional block diagram illustrating an ecosystem where media campaign are being managed, in accordance with some embodiments;

FIG. 2 is an example functional block diagram illustrating the campaign manager, in accordance with some embodiments;

FIG. 3 is an example flow chart for the process of managing media campaigns, in accordance with some embodiments;

FIG. 4 is an example flow chart for the sub-process of validating a keyword, in accordance with some embodiments;

FIG. 5 is an example flow chart for the sub-process of assessing quality of the keyword, in accordance with some embodiments;

FIG. 6 is an example flow chart for the sub-process of keyword recommendation, in accordance with some embodiments;

FIG. 7 is an example flow chart for the process of enhanced monetization and campaign rollout of media, in accordance with some embodiments;

FIG. 8 is an is an example flow chart for the sub-process of media uploading, in accordance with some embodiments;

FIG. 9 is an example flow chart for the sub-process of monetization, in accordance with some embodiments;

FIG. 10 is an example flow chart for the sub-process of analytics aggregation, in accordance with some embodiments;

FIGS. 11-20 are example screenshots for the monetization of media, in accordance with some embodiments;

FIG. 21A-21D are example screenshots illustrating the effectiveness of the disclosed process for monetization if desired for the particular situation, in accordance with some embodiments;

FIG. 22 is an example screenshot for media analytics, in accordance with some embodiments;

FIG. 23 is an example screenshot for a login screen for the campaign management interface, in accordance with some embodiments;

FIG. 24 is an example screenshot for an analytics dashboard, in accordance with some embodiments;

FIG. 25 is an example screenshot for a campaign page, in accordance with some embodiments;

FIG. 26 is an example screenshot for a video information page, in accordance with some embodiments;

FIG. 27 is an example screenshot for a login screen for specific platform analytics interfaces, in accordance with some embodiments; and

FIGS. 28A and 28B are example illustrations for computer systems configured to embody the media monetization system, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to a novel means, systems and methods for the enhancing the accessibility of media which is uploaded onto websites, and further managing media campaigns to ensure effective outreach to intended audiences. These systems and methods may be particularly useful within social media settings, where existing means of media monetization via advertisement revenue are present, but which are plagued by the inability to have readily searchable media.

Note that while much of the discussion contained herein relates to media sites such as social networks, it is entirely possible that any content host may utilize the disclosed systems and methods. For example, other media sources, such as YouTube, news outlets, such as CNN online, and online retailers, such as Amazon, may all be considered “media platforms/sites” or “distribution channels” for the purposes of this disclosure. Further, advertisers may likewise be referred to as “ad providers”.

Also note, that the present disclosure is aimed, in particular toward YouTube as an exemplary social media site. In fact, the systems and methods described herein work equally as well with any media platform where the media is searchable by a title and/or description. When advertisement monetization is supported, then the media can likewise be monetized by the uploader. Likewise, while the media being discussed herein tends to be directed toward videos, any media type is possible depending upon the host platform.

Further, while much of the discussion herein is directed toward the generation of revenue stream based upon advertisements, or the redirection of user's to a retailer landing page, it is also possible to imagine that the disclosed systems and methods can generate other value for the user beyond advertisement revenue and exposure. This may include, for example, the ability to more effectively communicate ideas, business information, and other discourse. In fact, the present disclosure works equally well for marketers attempting to reach audiences with marketing content. In these circumstances, direct monetization of the content is not required, or even desired, since the purpose of the content accessibility is to convey a message to the audience. This message may be an advertisement or general information on a subject (such as politically motivated information).

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Media Campaign Management

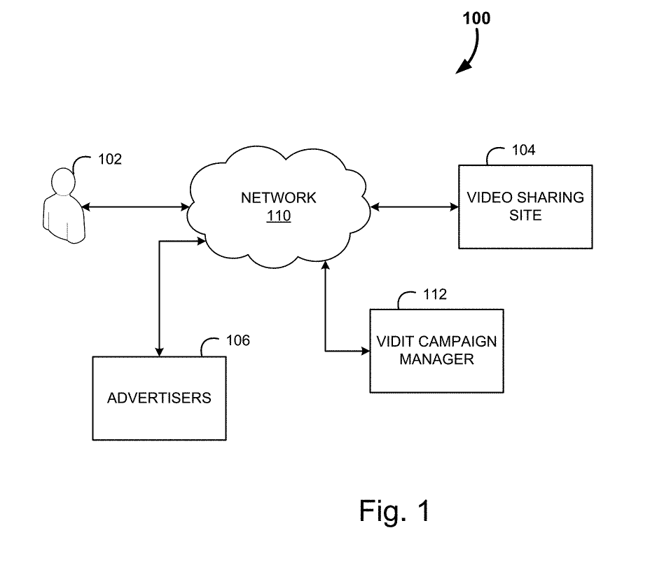

To facilitate the discussion, FIG. 1 is an example functional block diagram 100 illustrating users 102 engaging one or more media site 104. The user is the targeted consumer of the content being provided, in this example. Although a single user is illustrated, this element 102 is intended to encompass a large plurality of users who consume content hosted on one or more platforms 104. The media site 104 may in turn be in communication with advertisement providers 106, who are accessing a #vidit campaign manager system 112 that enables the management of the various campaigns from a consolidated interface. The campaign manager, in some embodiments may integrate with CRM platforms such as Salesforce, Infusionsoft, Hub spot and the like. All of the components are connected to one another via a network 110, which may include the internet, cellular networks, corporate networks, or any combination.

The video sharing site 104 may include any media site, including image sharing sites, social media sites, etc. Further, the media site may be a plurality of platforms. One example of an applicable media site includes YouTube, of course other media hosting sites and social networks are likewise usable. The media site 104 may also be referred to as a “content platform”, or more simply “platform”, “social media site”, “video sharing site”, “content host”, “social catapult sites”, or the like. Any such designation is intended to be utilized interchangeably without limitation to the media site 104.

Also note that in the context of this disclosure, almost anyone is capable of uploading content to the media site 104. However, as the present disclosure focuses on marketing and advertisements, the provider of the content for uploading is being referred to as the ‘advertisers’ 106. Of course, in alternate contexts, the advertisers 106 may include third party marketing agencies, non-governmental organizations, charities, public outreach government functions, or even individuals working to disseminate their content more effectively. Regardless of the type, the terms “advertiser” or “content provider”, for the purpose of this disclosure, are intended to incorporate all of these entities.

Typically, the media site draws revenue from its ability to include advertisement space onto the webpage. The content on the webpage must be compelling enough to warrant a viewer/user to suffer through the advertisement nuisance. In the case of YouTube, the advertisement level has been left up to the content provider who provides the video being uploaded. The rationale behind this mode of operation is that the user is most capable of gauging the advertisements appropriate for the given video clip. In exchange for the added revenue, YouTube enables the sharing of a portion of the advertisement revenue with the content provider. This incentivizes the content provider to upload compelling content, and widely disseminating the YouTube web address in order to maximize views and engagement.

The video sharing site 104 benefit from this arrangement by ensuring that advertising spots near the content they sell is viewed more frequently, and payments are only made when the advertisement is actually viewed.

In some embodiments, the advertiser 106 logs into the media site 104, and uploads the media that they wish to monetize/distribute. The media then receives advertisements from the media site 104 (through sales of advertising space to companies). By making the media highly searchable through the usage of unique hashtags, the media is able to generate more advertisement revenue than traditional media uploads. In alternate embodiments, the advertisers 106 may utilize the campaign manager 112 to select a unique keyword, upload content, and bulk administer campaign across the media sites 104.

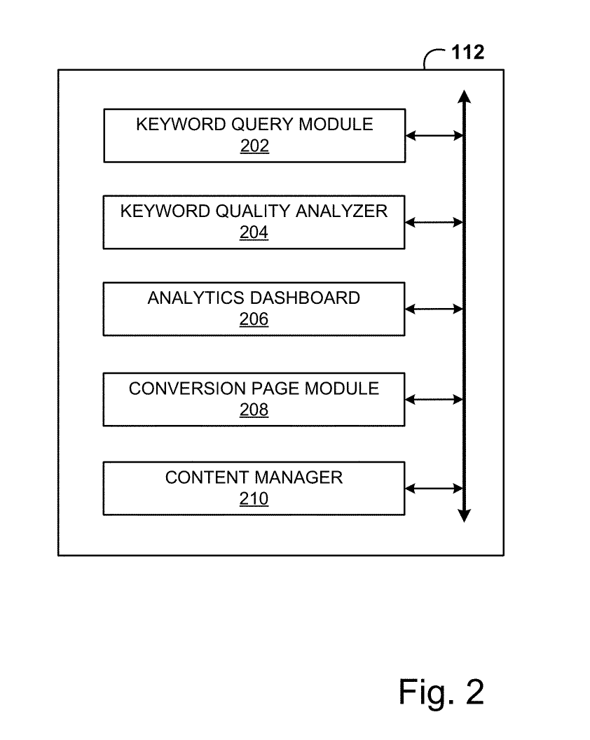

FIG. 2 provides a more detailed illustration of the components of the campaign manager 112. These components may include software and/or hardware modules physically or logically coupled to one another. These modules include a keyword query module 202, a keyword quality analyzer 204, an analytics dashboard 206, a conversion page module 208 and a content manager 210.

The keyword query module 202 may search internal databases for repeated keyword usage, thereby ensuring that advertisers 106 utilizing the campaign manager 112 do not interfere with one another, and ensuring users 102 consuming the content do not get distracted or confused. In addition to accessing internal datasets, the query module 202 may also access external data sources, in some embodiments. These may include one or more trademark databases and “banned” word lists. The query module 202 makes a basic determination of availability of keywords to a particular advertiser, whereas the keyword quality analyzer 204 instead provides analytics on the “quality” of the keyword selected. In some embodiments, the “quality” is determined by a number of factor, including length, valuations, and descriptiveness. For example, a keyword may be analyzed for valuations using Google AdWords Keyword planner, answerthepublic.com, keyhole. co, trackyourposition.com, or any similar tools. Generally these tools are publicly available, or available for a fee, and each use slightly different heuristics to arrive at the value of a keyword as a domain name. For example, Google AdWords may enable a user to search a term that they wish to associate with their advertisement. The Google AdWords system, specifically Keywords Search Tool uses information regarding the search frequency of the term, user behavior after searching the term, etc. to generate a cost associated with the term. Obviously Google is capable of charging a user more for a frequently used term, and terms that are more likely associated with user's looking to purchase a product or service. This tool thus provides a valuation data point that can be used alone, or in conjunction with other valuation tools, to determine a given word's “value”.

Other tools do not provide explicit “values” for words, but instead provide analytics related to usage trends of a term, questions associated with a term, or other analytics. These too can be used to generate “values” by the system. For example, usage trends may be readily converted into values with words searched more frequently being more valuable until a certain threshold. Above the threshold, the word may be considered “non-disambiguating” and typically includes words such as “the”, “an”, “but”, “more”, “vs” and the like. I addition, these trends may be geographically separated. Thus, for a particular advertiser with a brick and mortar store in a given region, the trends they care about may be limited to those occurring within that region. In addition to trends, some tools provide associated questions with the keyword, or other analytics. The number and variety of these questions may likewise be converted into a valuation.

In some embodiments, the valuations from any given tool may be normalized on a 1-100 scale in order to enable aggregation. For example if a Google AdWords has a valuation of $312 per click, this may be within the top quartile of fees charged by Google. This may translate into a normalized valuation of 75, whereas a lower quartile fee would normalize to a valuation of 25, and a median valuation by Google would normalize to 50 and the like. Similarly, if the trend of a word is common in a given region (say 1 in 1000 searches) this normalized valuation may be 90. A search that occurs less frequently (say 5 in 10,000 searches) may be a lower score, of say 40. This range of course will vary based upon the total number of searches performed in the region. For example is the region has 100,000 searches per day, a term occurring once per a thousand searches is very relevant (hence a normalized valuation of 90), but in a low volume region, say where there is only 3000 searches a day, a term that occurs once in a thousand searches is of much lower value.

Once valuations are determined using each tool, and normalized accordingly, they may be averaged to generate a final valuation score. This average may include a straight average, or may be a weighted average. For example, due to the relevancy and broad dataset used by Google, the Google AdWords valuation may be given a greater weight in the final valuation compared to trend based valuations. In some embodiments, a full half of the final valuation may depend upon Google AdWords results, and all other tools combined account for the remaining 50% of the final valuation. Of course, these weights may be user configured, in some embodiments.

The final valuation may be further modified in determining the quality of the keyword based upon keyword length. In some embodiments, keywords above six characters may be devalued progressively as the length increases. This is because users of the media sites are unlikely to type in very long keywords. In some embodiments, the valuations may be reduced by 10% for every character above six. The threshold number of characters before reducing value can be user configurable, as can the rate of devaluation.

Semantic analysis may also be utilized to modify the valuation level. This may be completed manually, or may utilize AI analytics/natural language processing (NLP) for determination of concepts within the keywords. The error rate/confidence level for the NLP classification may be used to modify valuations in some embodiments. Many natural language processing models perform classifications of a set of terms into a ‘category’. These categories are typically conceptual groups. If the model is able to readily determine the concept term(s) are associated with, then the confidence level for the classification is very high (usually presented as a percentage confidence level). If the terms do not readily convey a concept it may be difficult to classify the terms, thereby having a lower confidence level. How closely a term or set of terms associates with a concept may be helpful in identifying relevant keyword terms. Thus, the valuation may be multiplied by the confidence level, in some embodiments, to further refine the valuation level and determine a quality of the keyword.

Ideally, a keyword is found to be highly valuable, be short enough to be used readily, and convey a concept or topic quickly and clearly. This type of keyword will receive a high quality score. Longer, more ambiguous, and less valuable keywords will result in lower quality scores. The quality score may be compared against a minimum threshold by the quality module 204, and keywords determined to be too low may be rejected. The advertiser may be required to submit for another keyword, or the system itself may furnish alternative, higher ranked, suggestions of keywords. Suggestions may be formulated through human intervention, and by synonym replacement and rescoring of possible keyword permutations, as will be described in greater detail below.

After a keyword has been selected, the content manager 210 may allow the advertiser to upload content associated with the keyword to the campaign manager 112. The advertiser may then link the campaign manager 112 to accounts held on the various media sites 106. The advertiser may then manually upload the content to the media sites 106 along with the keywords, or the campaign manager 112 may automatically bulk upload the content and keywords to the various media sites 106. In some embodiments, the campaign manager system may couple to an external system specializing in identification target customers based on the nature of the content, and viewer characteristics garnered from social media posts, online forums, blogs, and influencers followed. An example of such a third party targeting group includes Findyourinflunece.com or the like.

The uploaded content may be linked, within each media site 106, to a landing page for users who wish for more information. The landing page associated with any given campaign may be referenced by the conversion page module 208. In this manner, the advertiser may keep track of the linkage between the media campaigns occurring on the many third party media sites 206 and the corresponding information within their own wed domains.

Lastly, the analytics dashboard 206 may leverage API to aggregate and consolidate metrics for the campaigns across the various media sites 206. This may include providing information related to click-through rates, geographic distributions of users viewing the relevant content, trends, user demographics, etc.

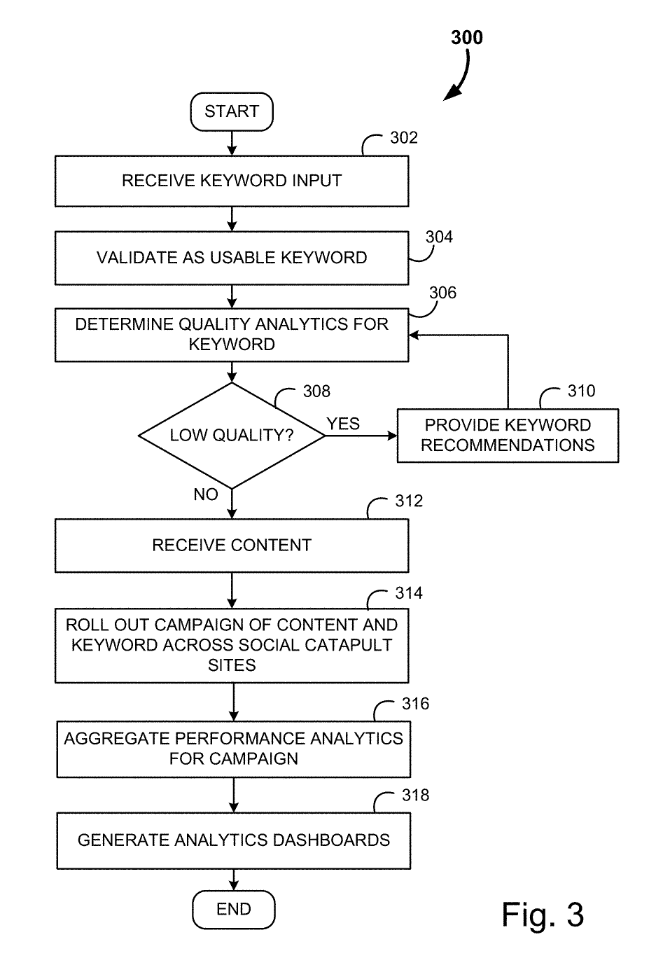

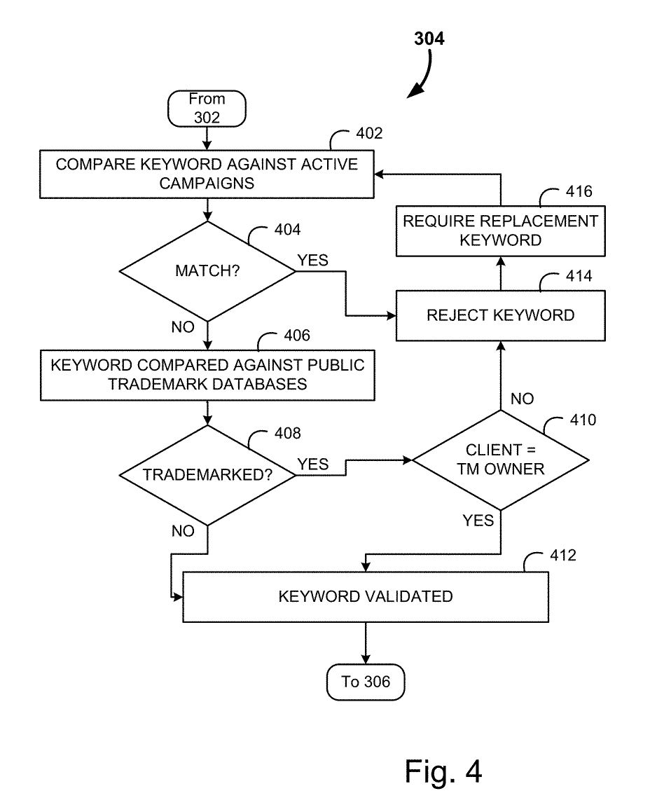

The process for managing content utilizing the above systems will now be disclosed in reference to FIG. 3, shown generally at 300. In this example process, initially the system receives a keyword form the advertiser (at 302). This is typically performed via a freeform text input available on an interface accessible by the advertiser. Next the keyword is validated (at 304) via a process described in greater detail in FIG. 4. In this process, the keyword is initially compared against a listing of keyword that are involved in active campaigns (at 402), or recently active campaigns, or long term periodic campaigns where the keyword has been reserved. If there is a match (at 404), then the keyword may be rejected (at 414) and a replacement keyword may be requested from the advertiser (at 416) which is then again subjected to validation.

However, if the keyword is not associated with a current campaign, the next step may be to compare the keyword with public trademark databases (at 406) to determine if the term is under any legal risk if utilized. If trademarked (at 408) a determination may be made whether the advertiser is the same as the trademark owner (at 410). If not, then there is a critical issue with the keyword and the system may require the user to input a new keyword. However, if the keyword is not trademarked, or of the advertiser is the owner of a trademarked keyword, then the keyword may be validated by the system (at 412). This returns then to FIG. 3, where the validated keyword is subjected to quality analysis (at 306).

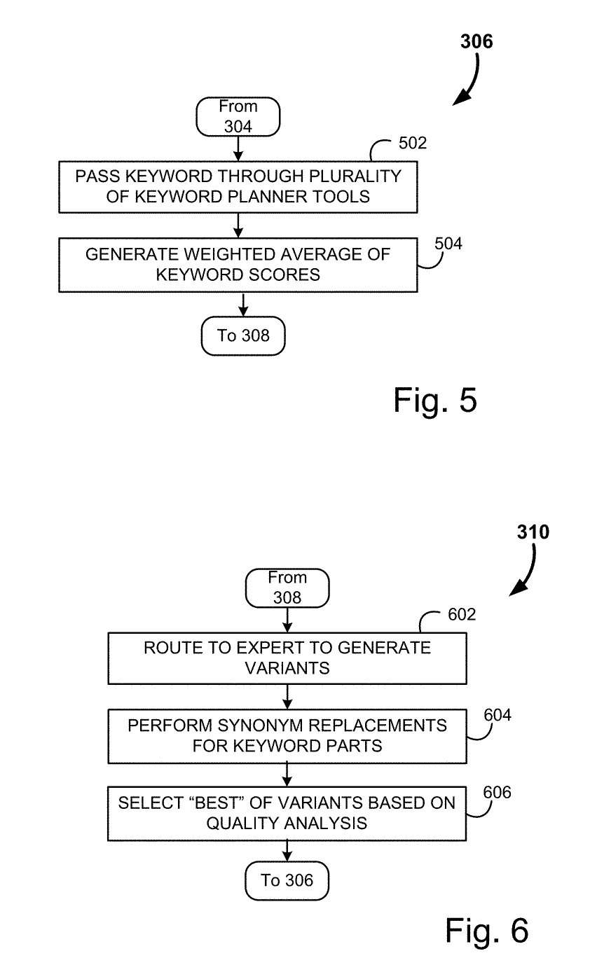

Quality analysis may include a subjective analysis by a person skilled in marketing on behalf of the advertiser, in some cases. In other embodiments, the quality analysis may be more objective, relying upon valuation tools that utilize semantics and search trends for the term in determining a value. FIG. 5 provides an example of one such process where the keyword is passed through a number of keyword planner tools (at 502), and then the valuations form these tools are averaged (at 504). As discussed in significant detail above, the tools may include Google AdWords or similar valuations, as well as semantic tools, and trend/search count tools. All valuations may be normalized, and the averaging may be weighted, in some cases. This final valuation may be used as a proxy for the keyword quality, or may be further refined by length of the term and semantic analysis to arrive at a refined quality measure, as previously discussed.

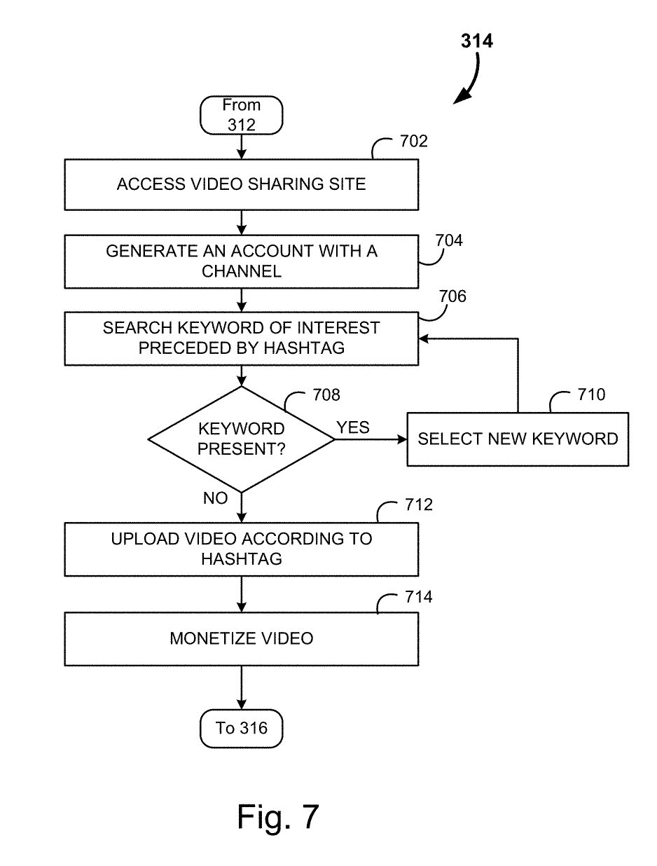

Returning to FIG. 3, after quality for the keyword is determined, an inquiry is made whether the quality is above an acceptance threshold (at 308). If not, then the system may generate keyword recommendations (at 310) which are provided to the advertiser for selecting a desired replacement keyword. This recommendation process is described in greater detail in relation to FIG. 6. Initially, the low quality existing keyword may be routed to an expert individual to determine alternate keyword variants (at 602). The system may then take these variants, and the original low quality keyword, and substitute each element with synonyms to generate a larger set of possible keywords (at 604). This larger set may then be subjected to filtering according to the same criteria used in validation (not shown) to eliminate any possible conflicting keywords or trademarked keywords. The remaining set of keywords may be subjected to a process similar to that used to determine keyword quality, and the top keywords may be output as the “best” keywords (at 606).

For example, say the initial keyword requested is #greatvehicles, and the quality score is below the required level. A user may suggest #carsale and #greatChevy. The synonym replacements would then generate a wide variety of permutations, including #bestcars, #cardeals, #awesomecars, #bestChevy, etc. The system then reviews all options, and determines which of the permutations have the highest quality scores. For example, #bestChevy and #cardeals.

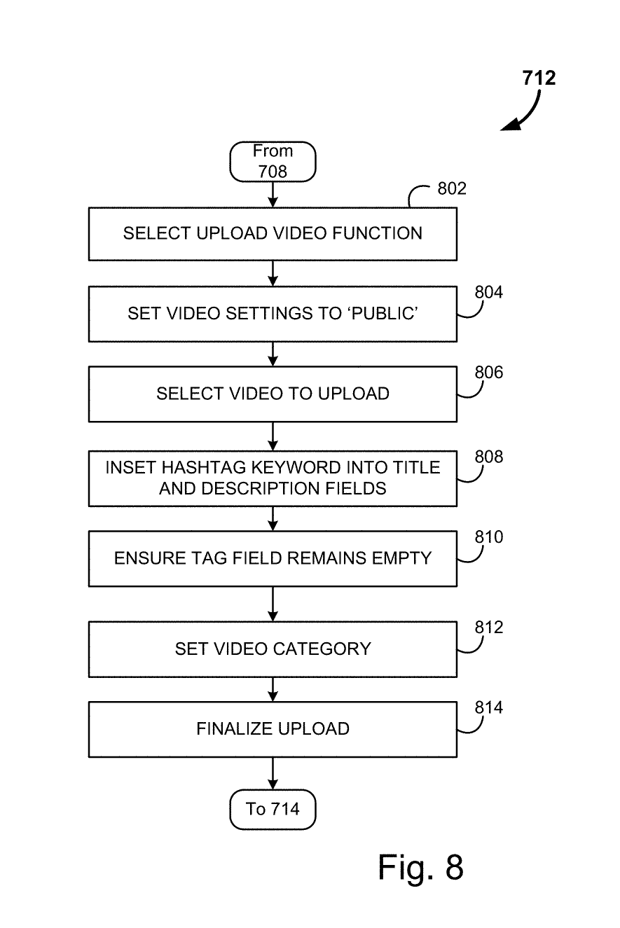

Returning to FIG. 3, once a keyword is identified that is above the required quality threshold, the next step is to receive the content that is to be associated with the selected keyword (at 312). Next the keyword and content may be rolled out across the one or more media sites (at 314). This roll out may be done manually by the advertiser, but in some embodiments may be automated by the campaign manager once the media sites accounts for the advertiser is linked to the campaign manager. FIG. 7 provides a more detailed illustration of this campaign rollout.

Initially the advertiser or the campaign manager accesses a media sharing site (at 702). As previously noted, the media site may be a video sharing site, such as YouTube, or other site that enables the uploading and monetization of media. Likewise, the media may consist of video files, or alternate media, such as images, audio files, text articles, or even executable files.

After accessing the media sharing site, the user will open a blank screen on the sites. For the purposes of this disclosure, a “blank screen” means a newly opened browser screen where none of the fields have been populated, and cookies have been cleared. The blank screen ensures that any subsequent searches for keywords is an accurate representation of the keyword prevalence.

Next the user generates an account with a channel for presenting her media (at 704). The generation of an account is important because it enables the correct routing of the advertisement revenue to the user. Next the user searches for a keyword of interest preceded by a hashtag (at 706). This search of the keyword is important because even if the keyword has already been validated as being available in the campaign manager system, it may still already have been utilized in the media site and therefore unavailable for usage.

The hashtag is placed in front of the keyword in able to assist in the generation of a unique keyword. In addition, the hashtag has gained popularity due to the expansion of twitter as a media platform. Thus, keywords preceded by a hashtag are readily adopted by users, and the searching of hashtagged keywords is understood by media consumers.

Of course, it is also possible to substitute any other symbol instead of the hashtag in the generation of the unique keyword. For example, instead of the hash (#), an exclamation point (!), an @ symbol, a dollar sign ($), a percentage symbol (%), an ampersand (&), an asterisk (*), a bracket symbol ([,{,],}), a carat symbol (̂), an underscore (_), or a plus sign (+) may be utilized. Thus, it is considered that anytime within this disclosure the term “hashtag” is used, this term describes a class of special symbols as outlined above.

Next, the media platform queries its databases to determine if the hashtagged keyword is presently being utilized (at 708). If the hashtag keyword is already being utilized, the content uploader selects a new keyword (at 710) and performs another search utilizing the newly selected keyword (at 706). In this manner the content uploader recursively searches various keyword combinations in order to identify a hashtag keyword that is unique.

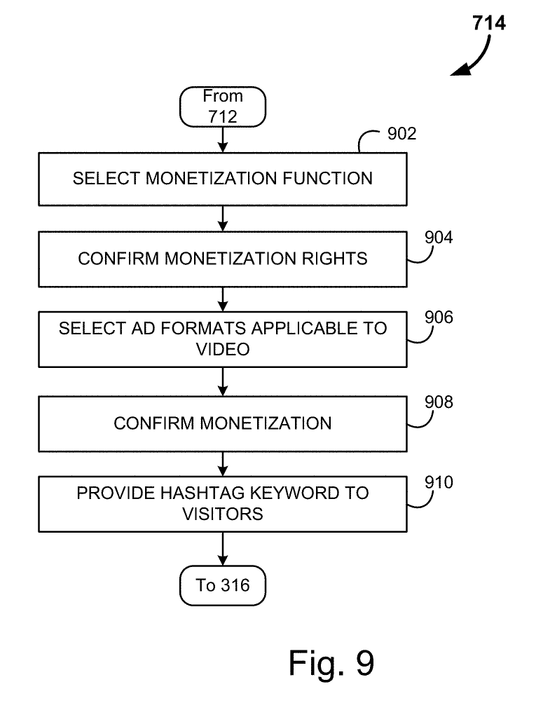

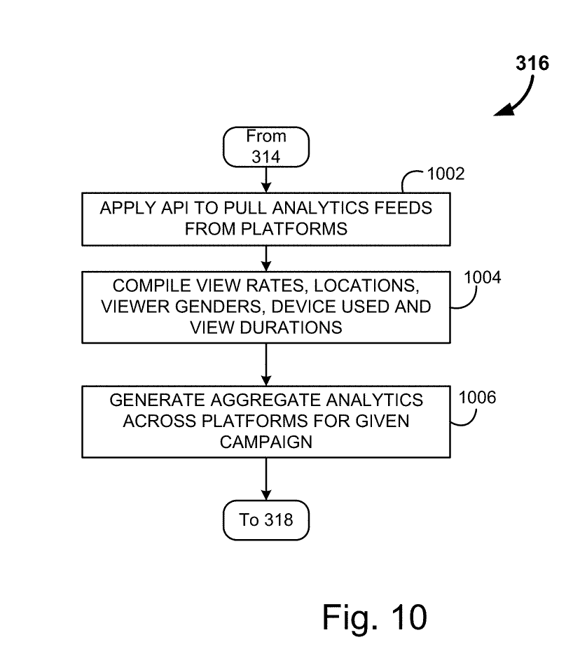

Once a unique hashtag keyword is identified, the media may be uploaded according to the hashtag (at 712). This process of media uploading is disclosed in greater detail in reference to FIG. 8. In this example process, the content uploader selects an upload function from the media platform (at 802). Often, media sharing sites include a button labeled “upload” in order to initiate the media sharing.

Next, in this embodiment, the content uploader selects a number of configurations for the media. This may include designating that the media is to be public (at 804), and may include other configurations dependent upon the media sharing platform. For example, some media sharing platforms may require designation of viewer guidelines (e.g., general audiences, mature content, etc.).

Subsequently, the media is selected from the content uploader's computer for uploading (at 806). This typically includes browsing the content uploader's local files for the appropriate media file, selecting it, and uploading it. The media site typically provides a status bar indicating the progress of the media upload.

Next, based upon the media sharing platforms requirements, the content uploader may be allowed to insert descriptors for the media in order to allow for media searching and for display to viewers. In some embodiments, this includes inserting the hashtag keyword, which was determined to be unique, into the media title and description fields (at 808). In contrast, the tag field should remain empty (at 810). This ensures that searches for the hashtag keyword yield the appropriate results.

Additionally, if required by the media sharing platform, the media category is set (at 812), and any additional designators for the media are set. For example, some media platforms may require the type of media be designated (e.g. video, image, audio file, etc.).

Lastly, the uploading of the media may be finalized (at 814) whereby all the content uploader's inputs are saved. The media then becomes available to the public for viewing.

Returning to FIG. 7, after media uploading, the process concludes with the monetization of the media (at 714). This monetization step is further disclosed, in greater detail, in relation to the flowchart illustrated in FIG. 4.

In this example flow diagram, the monetization function within the media sharing platform is selected by the content uploader (at 902). In some media platform it is also possible that monetization occurs automatically, or is compulsory. In these scenarios, the selection of the monetization function is not required.

The content uploader is often required to confirm that the monetization rights belong to them (at 904). This step ensures that the media sharing platform does not get dragged into copyright disputes among independent parties. The content uploader may also be able to select advertisement formats applicable, or desired, for the media (at 906).

For example, many media types lend themselves to banner advertisements. However, video content may also be well situated to play a short commercial prior to the video. Likewise, an intermediate advertisement may block out media in the format of pictures or text for a set period of time. Additionally, some media itself may include product placement or product critiques. These media types themselves may be eligible for advertisement revenue. In media platforms that enable selection of the advertisement format, typically the more advertisements selected impacts the rate of monetization, but may also impact the viewership.

After advertisements are formatted, the content uploader confirms the monetization configurations (at 908). The content uploader may then disseminate the hashtag keywords to others (at 910) in order to initiate the advertisement revenue stream. As the hashtag keyword is unique to the content uploader's content, it will naturally and organically migrate to the top of searches performed for it. This occurs immediately on the media platform, but will rapidly migrate out into search engine results.

Top search result positions are coveted as directly and substantially impacting page views and associated revenue generation. Unique hashtagged keywords enables the content uploader to maintain this prime real estate, and minimizes the risk of viewers being sidetracked from the intended media.

Further, by linking the hashtagged keyword to a broader marketing campaign, the brand recognition is exponentially impacted. This ensures interested customers are seeking out only the intended media, and won't be diverted to related competitor products.

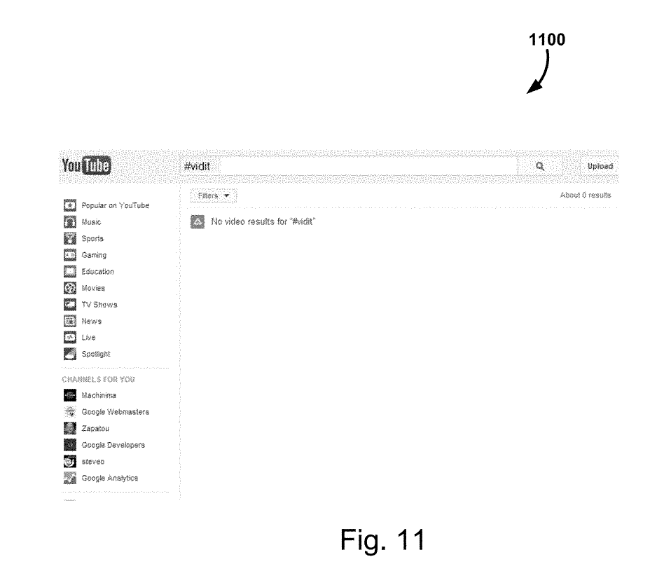

Returning to FIG. 3, after the campaign has been thus administered, performance analytics for the campaign may be aggregated (at 316) and used to generate an analytics dashboard (at 318) to provide the advertiser with insights into the effectiveness of the campaign. FIG. 10 provides a more detailed flow diagram of the analytics aggregation step. Initially a plurality of APIs may be applied to the various media platforms in order to pull their analytics feeds (at 1002). The view rates, viewer locations, viewer's gender, device type, and viewing durations are all compiled from these feeds (at 1004). This compiled data set may be utilized to generate aggregated analytics by combining data from the various platforms (at 1006) as well. In this manner, the dashboard may provide information on specific media sites, as well as overall campaign performance.

### II. Examples

Now that the systems and processes for campaign management has been disclosed in considerable detail, attention will be turned toward example screenshots of the media being uploaded to a media site, and subsequently the campaign manager interface. These examples are implemented on YouTube, a video sharing site, within the context of direct advertisement monetization. As previously noted, the above disclosed process for media monetization may be performed with any appropriate media sharing platform, and any appropriate media type; however, for the sake of simplicity, these example screenshots will be directed toward video media being uploaded onto YouTube. Also note that a similar process may be employed where direct monetization is not a primary consideration, but rather increasing accessibility of the content is of paramount importance, as discussed in the previous section.

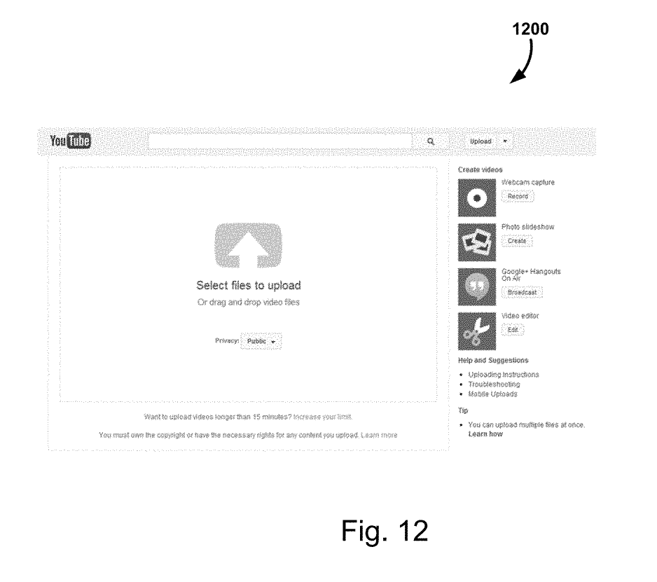

FIG. 11 initially shows a YouTube search page, shown generally at 1100. The user has logged into the website, and has started with a blank search page initially. The user then selects a keyword preceded by a hashtag to determine if it is unique. In this example screenshot, the user searches for “#vidit” which returns a result that indicates that no other videos have been uploaded that are related to this term.

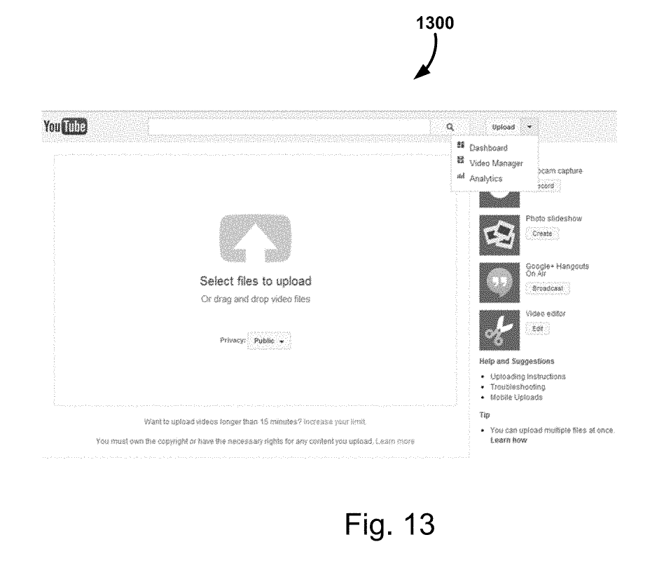

Now that the user has identified a unique hashtag keyword, the user selects the “upload” button in order to get to the page for loading the video file, as seen at 1200 of FIG. 12. The privacy setting, in this example, is selected as being public.

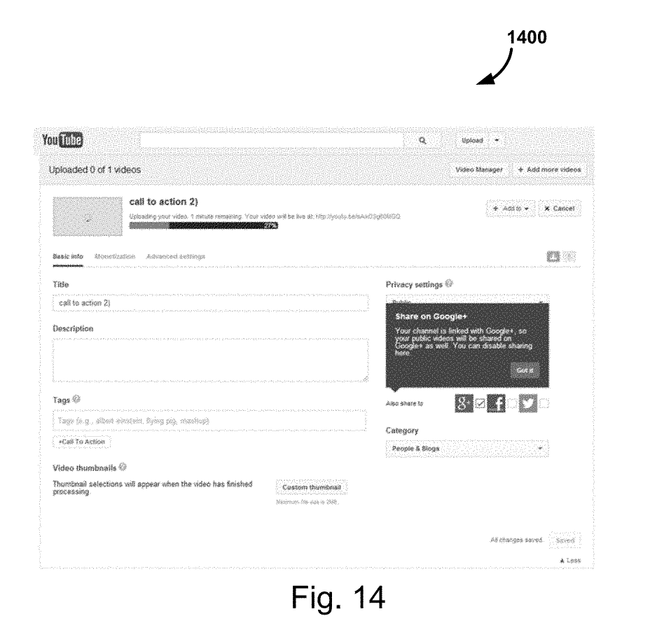

The user, in this example, may then select the pull-down menu, shown generally at 1300 of FIG. 13, in order to select the appropriate function. Here, the user selects the “video manager” option in order to be directed to a page where the video file may be uploaded.

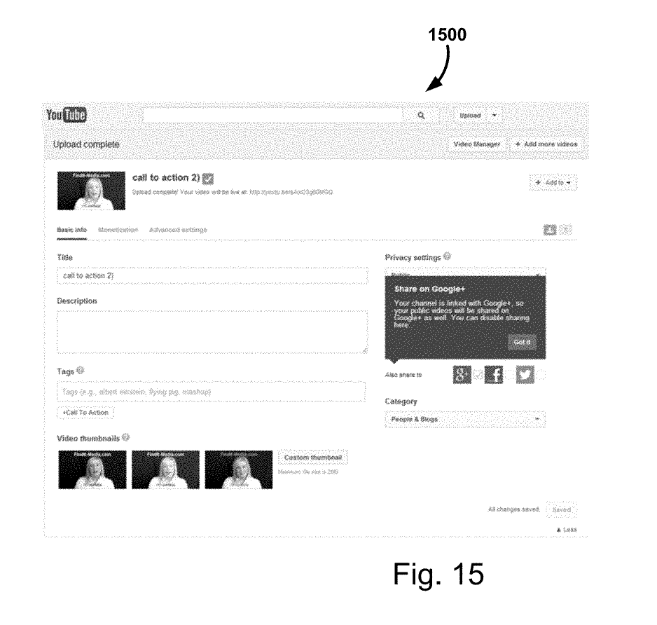

The uploading screen is seen generally at 1400 of FIG. 14. This example screenshot enables the user to select the file to be uploaded, provides a status of the upload, and enables the inputting of information related to the video file. As seen in this example image, the title if often defaulted upon upload to the file name. This is updated by the user to the unique hashtag keyword in order to ensure the desired searching outcomes.

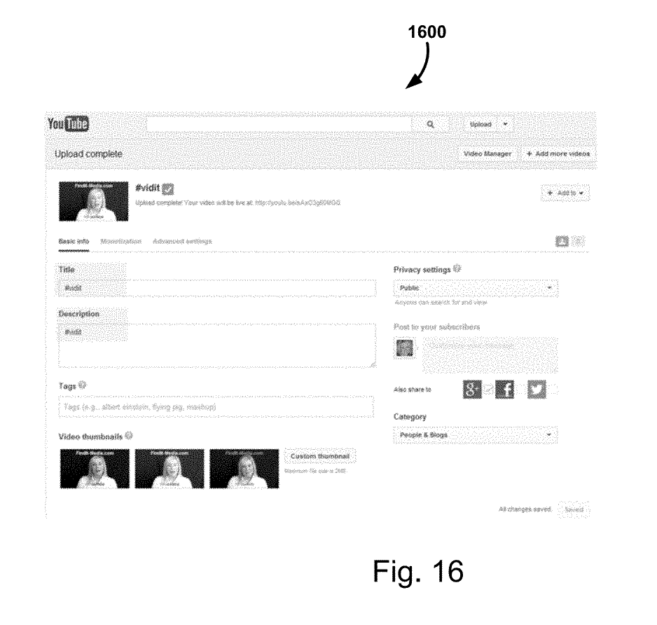

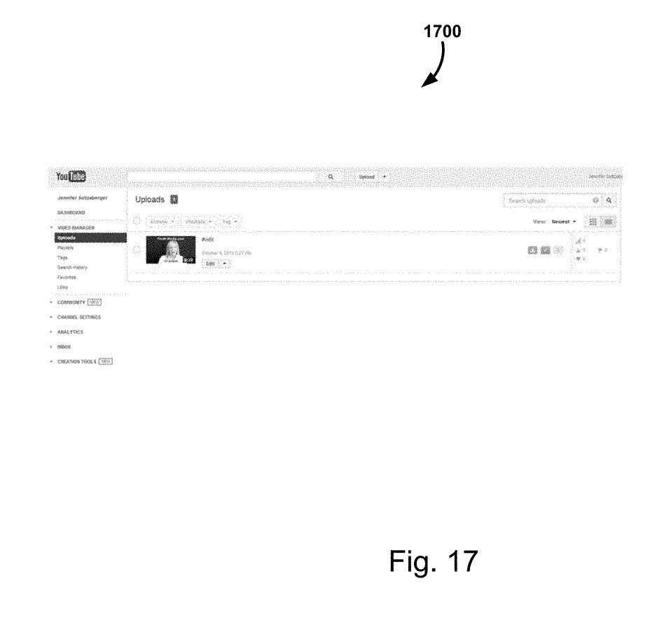

By way of example, FIG. 15 illustrates that the file has been fully uploaded, shown generally at 1500. In FIG. 16 the user has replaced the title and the description fields with the unique hashtag keyword, seen generally at 1600. Not that the ‘tag’ field remains blank to ensure proper searching. At this stage the video category may also be selected, and the privacy setting may be updated.

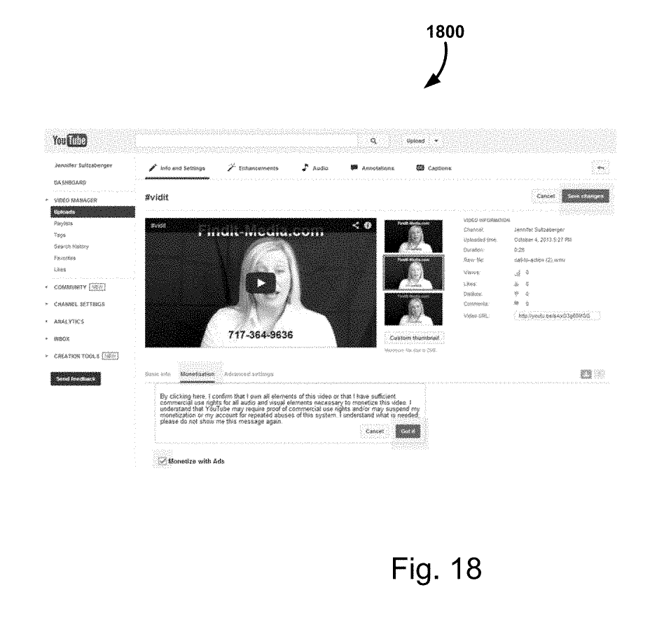

All changes to the upload are saved, and the user may be redirected to a page that displays their uploaded files, seen generally at 1700 of FIG. 17. From this page the user is able to update the monetization settings for the video by selecting the “$” icon next to the uploaded video. Again, this direct ad monetization may be of importance in circumstances where the content is being provided for that purpose. This monetization step may be avoided, however, when the primary purpose of the unique hashtagged keyword is merely to increase the accessibility of the content.

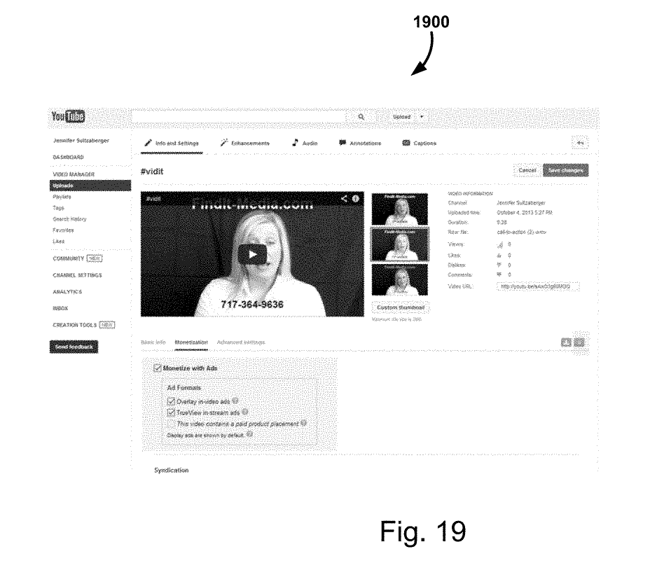

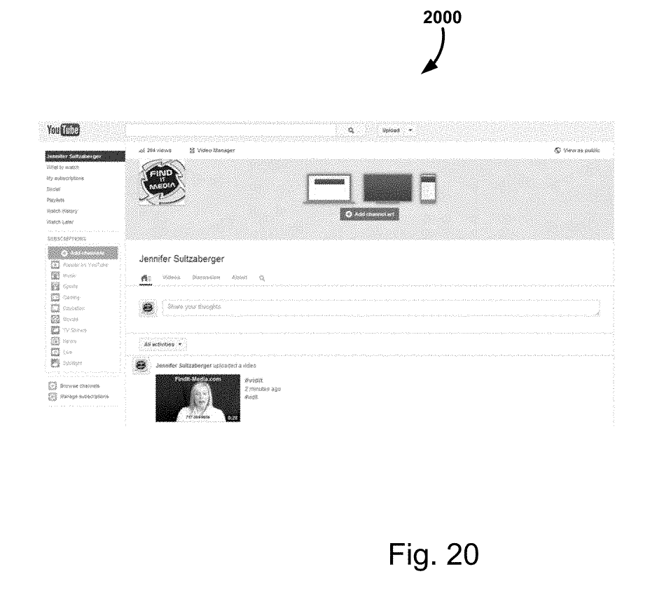

Returning to the example screenshots, selecting the “$” icon takes the user to a monetization screen, shown at 1800 of FIG. 18, where the user confirms that they have the rights to earn revenue on the uploaded content. After confirming this, the user is directed to a page where monetization configurations are made. These configurations include the selection of which advertisements are to be displayed in association with the video, for example. This monetization configuration page may be seen generally at 1900 in reference to FIG. 19.

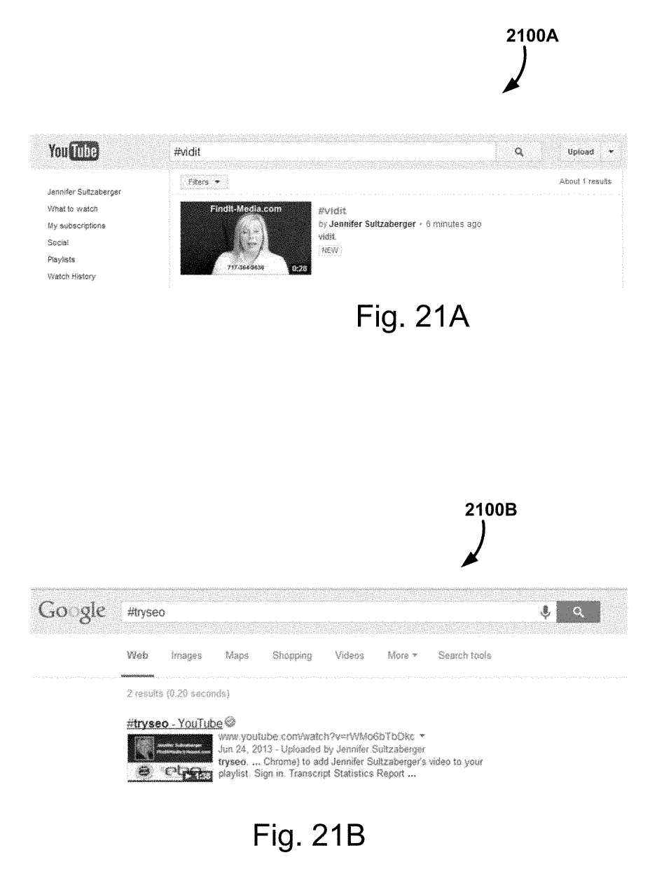

Lastly, by confirming the monetization selections, the user is sent to a final confirmation screen, shown generally at 2000, in relation to FIG. 20. This confirmation screen ensures the user that the video has been fully uploaded and is now ready for public viewing.

As previously noted, the use of a unique hashtag keyword inserted into the title and description fields, while maintaining the tag field blank, ensures that the media file is organically routed to the first position when searched for. This occurs very quickly within the host platform, and migrates over time to other search engines.

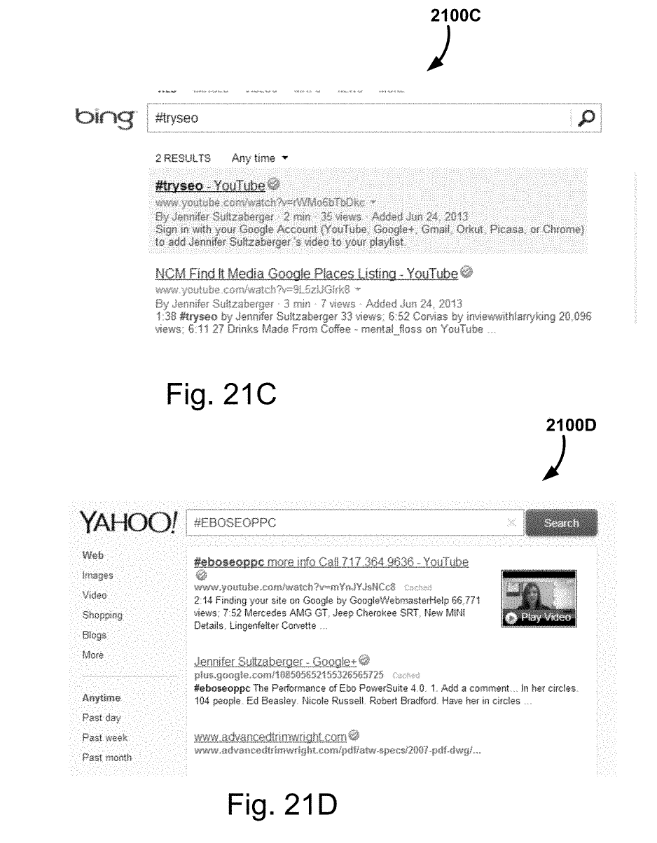

FIGS. 21A-21D are example screenshots illustrating the effectiveness of the disclosed process for monetization, in accordance with some embodiments. As can be seen in FIG. 21A at 2100A, the hashtag coupled with the unique keyword video comes up as the number one search result in YouTube within minutes of being uploaded.

Shortly thereafter, a hashtagged video organically becomes available on search engines that are associated with the media platform. YouTube is owned by Google, and as such the hashtagged video organically becomes the first search result in Google search engine very rapidly after video upload (typically within a day). This can be seen as illustrated in FIG. 21B at 2100B.

Within a few weeks, the hashtagged keyword can be inputted into other disassociated search engines and the media file is still seen as the first result. FIGS. 21C and 21D illustrate search results using bing and Yahoo! Search engines, at 2100C and 2100D respectively.

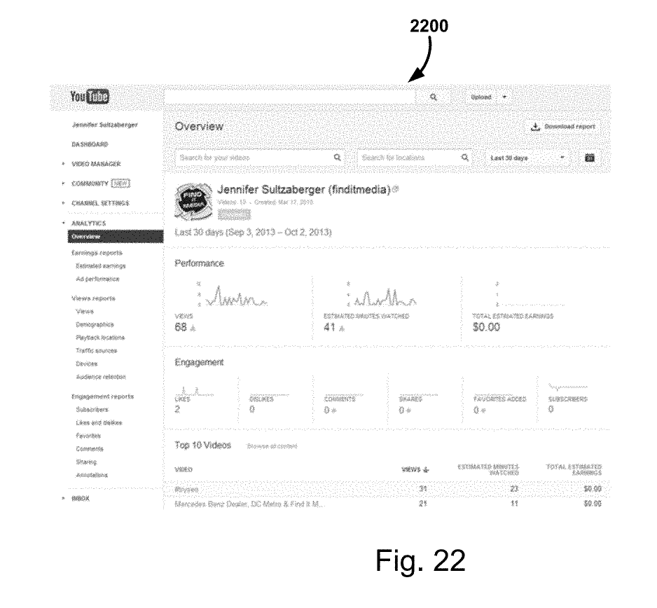

An additional benefit of using an isolated video (media file associated with a unique hashtag keyword) is the ability for the user to go back into the media platform and leverage onboard analytics. For example, FIG. 22 is an example screenshot for media analytics on YouTube, seen generally at 2200.

These analytics may provide the user an indication of media playback locations and traffic sources. These analytics may be utilized by the user to assist in business planning by assisting in the targeting of specific business channels and target audiences.

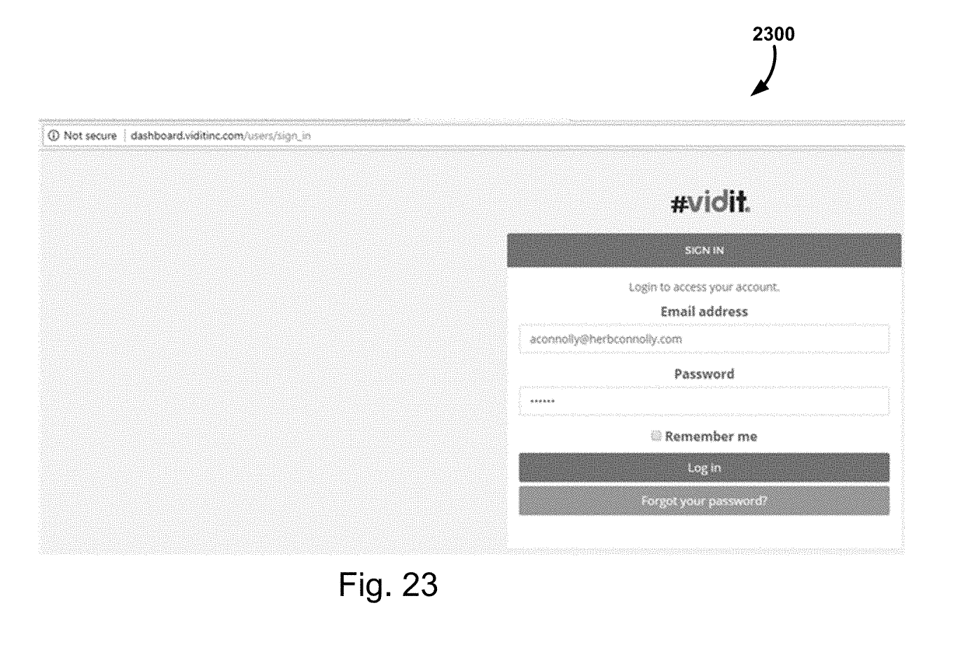

Moving on, FIGS. 23-27 provide screenshot images of the campaign manager interfaces. At FIG. 23 a login screen is illustrated at 2300. By having user accounts associated with a given advertiser, the campaign information may be only be accessed by the proper individuals, and further this allows linkage of accounts on the various media sites to the campaign manager account associated with the advertiser.

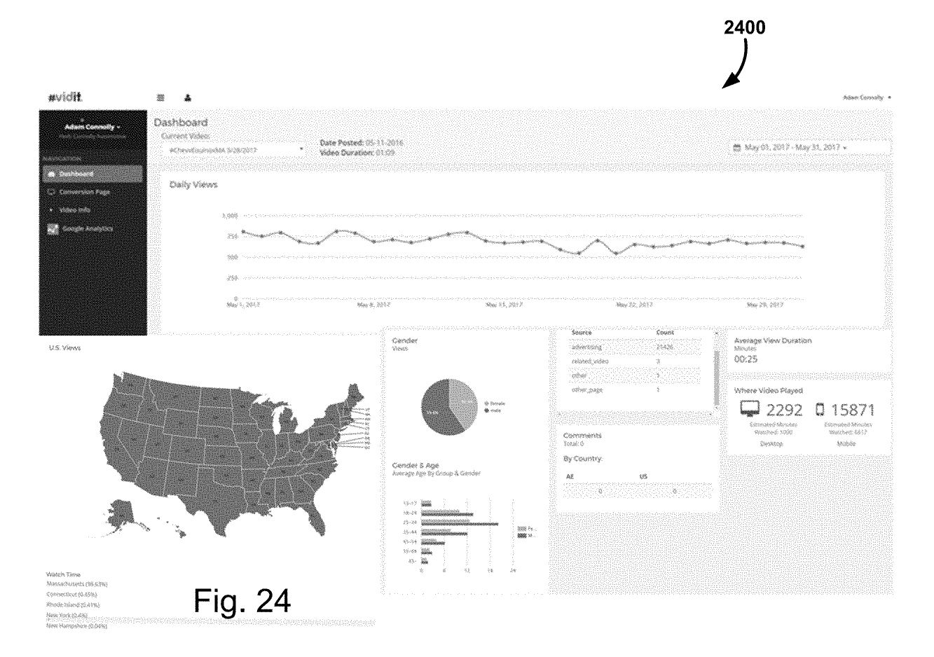

After logging in, the advertiser may be directed to a campaign dashboard as seen in FIG. 24 at 2400. This dashboard provides analytics associated with a given campaign, including viewing rates, location of views in the US (or other region of interest), demographic information of the viewers (such as gender, age, device used to view, etc.), source count, view duration, etc. This information may be pulled from one or more media sites using APIs and compiled into consolidated campaign metrics.

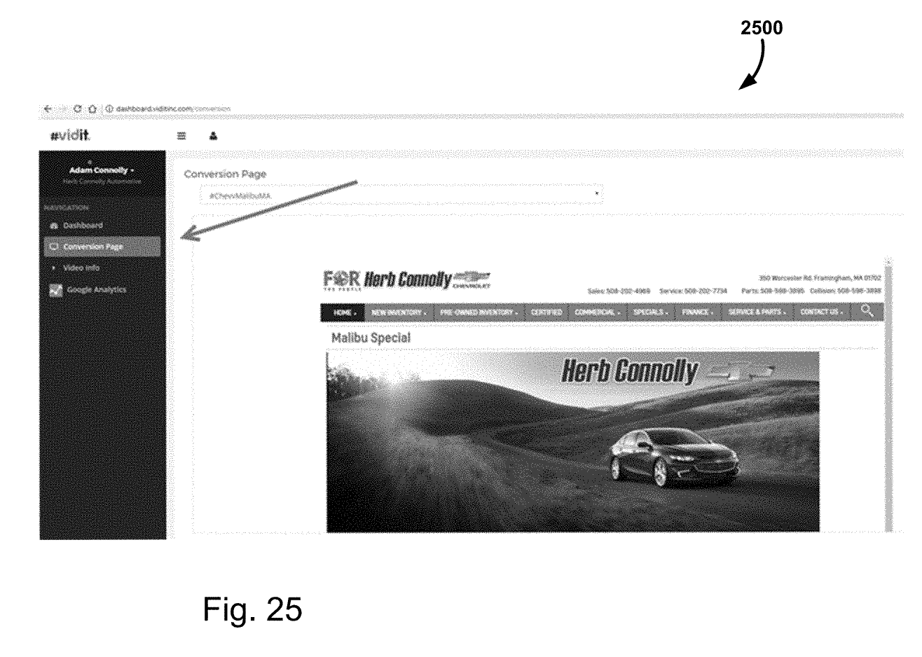

On the left hand side of the interface is a navigation box that allows the individual to access other interfaces of the campaign manager. When the “conversion page” link is selected, the individual may be taken to a rendering of the landing page associated with a given campaign, as seen at FIG. 25 at 2500. Typically, the uploaded content on the various media platforms will allow visitors to select “learn more” or other similar redirections. It is important that when this occurs, the viewers are redirected to a correct page on the advertiser's website. For example if the content is associated with a sale on Malibu cars, and the viewer is redirected to just a default page rather than a page associated with this sale, the viewer may feel disheartened and that searching for the deal information is too difficult. Worse, some viewers may feel tricked by the advertisement, and may foster negative feelings toward the advertiser. For this reason, managing landing pages for the various campaigns is of high importance.

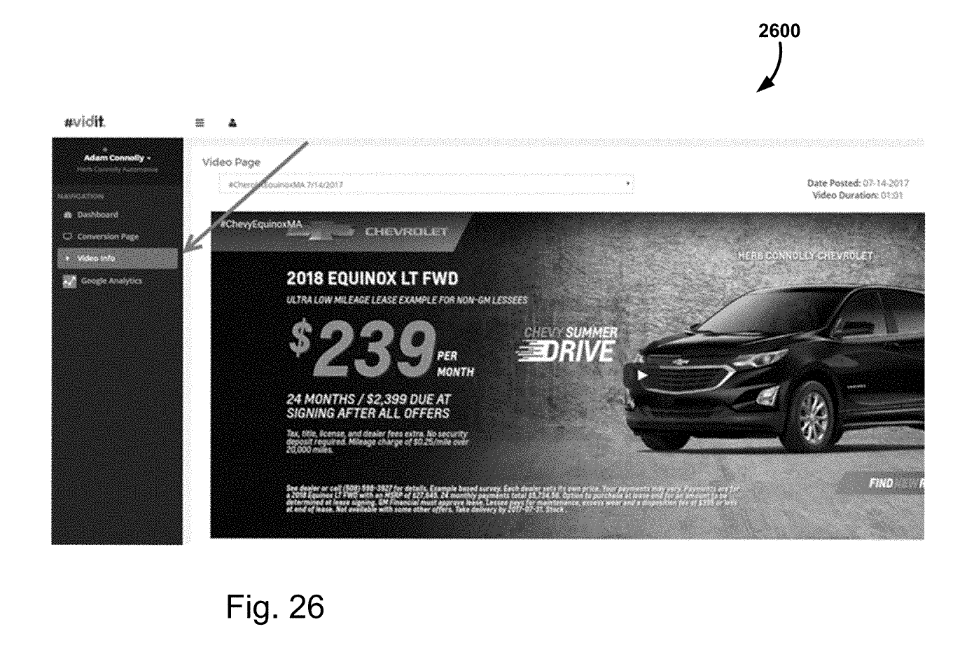

If the “video info” link is selected in the navigation pane, the advertiser may be sent to a video interface where the content that is located on the various media sites is displayed, as seen in FIG. 26 at 2600. This interface allows the advertiser to readily keep track of the content associated with a given campaign, and further allows modification or uploading of content.

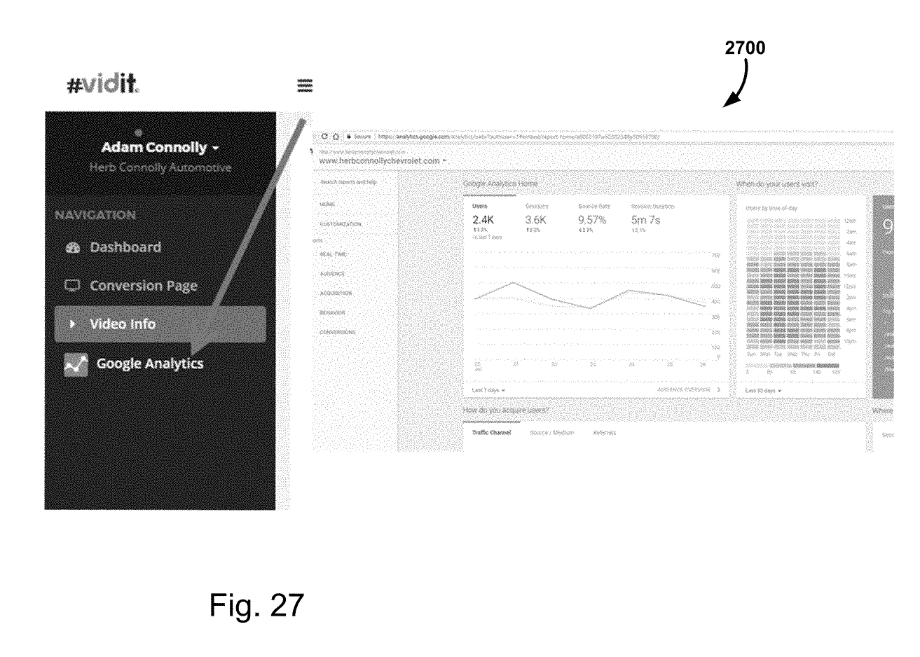

Underneath the “video info” link on the navigation pane is a listing of media sites that the content has been uploaded to. By selecting one of the media sites, the advertiser may be shown analytics associated with the given platform. In these examples only Google analytics is shown, but any number of platforms may be listed as determined by campaign distribution. In FIG. 27 the Google analytics for the example campaign is seen, in relation to 2700. This may be done by opening a webpage to the analytics within the campaign manager interface, or may leverage APIs to pull the information. The analytics shown may vary based on the platform used. For example, Google provides view rates, times that views occur, how viewers are acquired, etc. Different platforms may produce differing analytics.

### III. System Embodiments

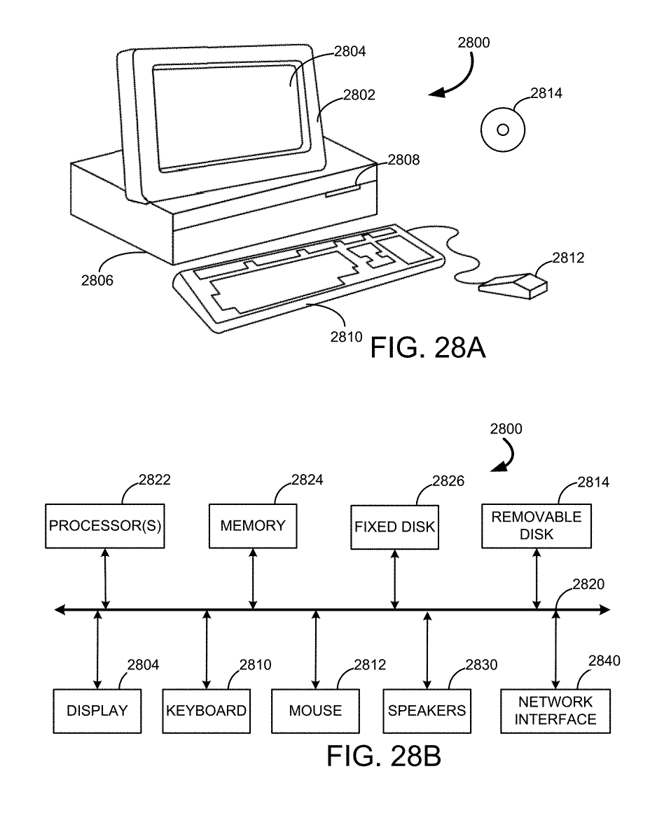

FIGS. 28A and 28B illustrate a Computer System 2800, which is suitable for implementing embodiments of the present invention. FIG. 28A shows one possible physical form of the Computer System 2800. Of course, the Computer System 2800 may have many physical forms ranging from a printed circuit board, an integrated circuit, and a small handheld device up to a huge super computer. Computer system 2800 may include a Monitor 2802, a Display 2804, a Housing 2806, a Disk Drive 2808, a Keyboard 2810, and a Mouse 2812. Disk 2814 is a computer-readable medium used to transfer data to and from Computer System 2800.

FIG. 28B is an example of a block diagram for Computer System 2800. Attached to System Bus 2820 are a wide variety of subsystems. Processor(s) 2822 (also referred to as central processing units, or CPUs) are coupled to storage devices, including Memory 2824. Memory 2824 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 2826 may also be coupled bi-directionally to the Processor 2822; it provides additional data storage capacity and may also include any of the computer-readable media described below. Fixed Disk 2826 may be used to store programs, data, and the like and is typically a secondary storage medium (such as a hard disk) that is slower than primary storage. It will be appreciated that the information retained within Fixed Disk 2826 may, in appropriate cases, be incorporated in standard fashion as virtual memory in Memory 2824. Removable Disk 2814 may take the form of any of the computer-readable media described below.

Processor 2822 is also coupled to a variety of input/output devices, such as Display 2804, Keyboard 2810, Mouse 2812 and Speakers 2830. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2822 optionally may be coupled to another computer or telecommunications network using Network Interface 2840. With such a Network Interface 2840, it is contemplated that the Processor 2822 might receive information from the network, or might output information to the network in the course of performing the above-described media campaign management process. Furthermore, method embodiments of the present invention may execute solely upon Processor 2822 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, the present invention provides systems and methods for enhanced media accessibility for the purpose of reaching greater audiences or for direct media monetization. Such systems and methods enable users to improve the search ability of their media, and thereby enhance advertisement revenue, reach to target audiences, and dissemination of information.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computer implemented method for managing a media campaign comprising:
receiving a keyword;
validating the keyword against an internal database of active campaign keywords;
assessing keyword quality using an external valuation platform;
recommending alternative keywords if the assessed quality is below a threshold;
receiving content associated with the keyword;
uploading the keyword and content on at least one platform;
collecting performance analytics form the at least one platform using at least one API; and
displaying the performance analytics, a landing page and the content on a plurality of interface pages.

2. The method of claim 1, wherein the keyword is preceded by a hashtag symbol.

3. The method of claim 1, wherein the validating further includes comparing the keyword against trademark databases.

4. The method of claim 3, wherein the validating confirms the keyword is received from a trademark owner when the keyword is trademarked.

5. The method of claim 1, wherein the assessing keyword quality further includes performing a weighted average of a plurality of external valuation platforms.

6. The method of claim 1, wherein the assessing keyword quality further includes modifying a quality score based on keyword length.

7. The method of claim 1, wherein the assessing keyword quality further includes modifying a quality score based on keyword semantic analysis.

8. The method of claim 1, wherein recommending alternative keywords utilizes a marketer suggestion.

9. The method of claim 1, wherein recommending alternative keywords includes synonym replacement of keyword components.

10. The method of claim 1, wherein the collected performance analytics are aggregated across the at least one platform to generate campaign analytics.

11. A system for managing a media campaign comprising:
an interface for receiving a keyword;
a query module for validating the keyword against an internal database of active campaign keywords;
a quality analyzer for assessing keyword quality using an external valuation platform, and recommending alternative keywords if the assessed quality is below a threshold
the interface further for receiving content associated with the keyword;
an onboarder for uploading the keyword and content on at least one platform; and
an analytics engine for collecting performance analytics form the at least one platform using at least one API, and displaying the performance analytics, a landing page and the content on a plurality of interface pages.

12. The system of claim 11, wherein the keyword is preceded by a hashtag symbol.

13. The system of claim 11, wherein the query module further compares the keyword against trademark databases.

14. The system of claim 13, wherein the query module confirms the keyword is received from a trademark owner when the keyword is trademarked.

15. The system of claim 11, wherein the quality analyzer performs a weighted average of a plurality of external valuation platforms.

16. The system of claim 11, wherein the quality analyzer modifies a quality score based on keyword length.

17. The system of claim 11, wherein the quality analyzer modifies a quality score based on keyword semantic analysis.

18. The system of claim 11, wherein the quality analyzer utilizes a marketer suggestion when recommending alternative keywords.

19. The system of claim 11, wherein quality analyzer utilizes synonym replacement of keyword components when recommending alternative keywords.

20. The system of claim 11, wherein the analytics dashboard aggregates collected performance analytics across the at least one platform to generate campaign analytics.
